(19) United States
(12) Patent Application Publication
(10) Pub. No.: US 2025/0044748 A1
(43) Pub. Date: Feb. 6, 2025

(54) MORE ROBUST PROCESSING OF MEASUREMENT DATA WITH NEURAL NETWORKS

(71) Applicant: Robert Bosch GmbH, Stuttgart (DE)

(72) Inventor: Jan Hendrik Metzen, Boeblingen (DE)

(21) Appl. No.: 18/779,393

(22) Filed: Jul. 22, 2024

(30) Foreign Application Priority Data
Aug. 4, 2023 (DE) 10 2023 207 529.6

(51) Int. Cl. G05B 13/02

(52) U.S. Cl. CPC G05B 13/0265

(57) ABSTRACT

A method for processing measurement data in a neural network including a plurality of layers of neurons. In the method: inputs supplied to each neuron are processed according to parameters associated with the neuron to produce a work result; a group of neurons is selected; a target distribution for the work results of the neurons of the group is defined; an inverse cumulative density function of the target distribution is provided; the work results are mapped with a predetermined unit function onto unit values in an interval, so that the unit value associated with each work result occupies the same rank on the list of all unit values as the corresponding work result occupies on the list of all work results; normalized work results are calculated from the unit values using the inverse cumulative density function; the normalized work results are further processed to produce outputs of the neural network.

### FIELD

The present invention relates to the processing of measurement data with neural networks, as used, for example, for monitoring the environment of vehicles during at least partially automated driving.

### BACKGROUND INFORMATION

The at least partially automated driving of a vehicle and/or robot on a company premises or in public traffic requires constant monitoring of the environment of this vehicle and/or robot. This monitoring generates measurement data that must be evaluated with regard to a given task. For example, camera images or similar measurement data can be used to evaluate which types of objects are present in the environment of the vehicle and/or robot. Neural networks are often used for these tasks because they have the potential to generalize well to situations not seen during training.

Neural networks for processing measurement data are often organized in a plurality of layers. Outputs from neurons of at least one layer are then fed as inputs to neurons of at least one subsequent layer. In this way, the inputs fed to the neural network as a whole migrate successively through the entire neural network in a forward direction until they are mapped to the final outputs of the neural network as a whole in its last layer. Conversely, feedback obtained during training, typically in the form of the value of a cost function (loss function), is propagated backwards through the neural network. In this way, gradients are ascertained along which the parameters characterizing the behavior of the neural network should be varied in order to likely improve the value of the cost function.

In order to stabilize the training, normalization techniques are often used to bring certain groups of work results in the neural network to uniform sizes. This counteracts in particular the tendency for gradients to disappear or explode in magnitude at certain points in the neural network during back-propagation, which can severely hinder training.

### SUMMARY

Within the scope of the present invention, a method for processing measurement data in a neural network is provided. This network has a plurality of layers of neurons, wherein the outputs of neurons of at least one layer are fed as inputs to neurons of at least one subsequent layer.

The measurement data can in particular be, for example, camera images, radar images, lidar images, thermal images, and/or ultrasound images. In particular, radar data and lidar data can also be available, for example in the form of point clouds. Furthermore, the measurement data can also comprise time series of one or more measured variables.

The neural network can, for example, be designed as a classifier that processes the input of the neural network to produce classification scores with respect to one or more classes of a given classification. The neural network can, for example, be designed in particular as an image classifier.

According to an example embodiment of the present invention, in this method, inputs supplied to each neuron are processed to produce a work result of that neuron according to parameters associated with the neuron. This work result can already be the final output of the neuron, but also, for example, an intermediate result that is further processed in one or more further steps to produce the final output assigned to this neuron.

A group of neurons is now selected whose working results are to be normalized in the following. This group can be selected according to any criteria relevant to the application and can, for example, comprise all neurons of a layer or a portion thereof. For example, neurons whose contributions are shown to be relevant to a decision regarding a particular aspect of the application by an analysis of a feature map created by the layer, and/or by any other saliency analysis of the output of the neural network, can be included in the group.

A target distribution for the work results of the neurons of this group is defined. This is the distribution that the work results of the neurons should have after normalization. Furthermore, an inverse cumulative density function of this target distribution is provided. For each distribution function, such an inverse cumulative density function exists and assigns to each threshold value between 0 and 1 the smallest argument of the distribution function for which the distribution function exceeds this threshold value. The inverse cumulative density function is therefore also called the quantile function.

The work results are now mapped with a predetermined unit function onto unit values in the interval [0,1] so that the unit value associated with each work result occupies the same rank on the list of all unit values as the corresponding work result occupies on the list of all work results. This means that the mapping of the work results to the interval [0,1] preserves the ranking of the work results among each other. Nevertheless, the numerical distances between the work results can be compressed and/or stretched when mapped into the interval [0,1]. For example, if five work results have the numerical values 10000, 1000, 5, 3, and 2, these can be mapped to unit values 0.9, 0.89, 0.85, 0.4, and 0.1. The unit values are then in the same ranking order as the original work results. However, the difference between 10000 and 1000 in the work results is compressed to a difference of 0.01 and even the difference between 1000 and 5 is compressed to a difference of just 0.04 in the unit values. In comparison, it can certainly be considered to be stretching if a difference between 5 and 3 in the work results is mapped to a difference of 0.45 and a difference between 3 and 2 is mapped to a difference of 0.3 in the unit values.

Normalized work results are calculated from the unit values using the inverse cumulative density function. These normalized work results are further processed to produce outputs of the neural network instead of the original work results in the neural network.

It was found that by appropriately choosing the target distribution, the processing of the measurement data in the neural network can be made surprisingly robust against a domain shift with respect to the domain of the training data. Each normalization smooths out certain differences and changes in the inputs of the neural network in that these differences and changes are no longer evident in the result of the normalization. This means that the processing in the neural network becomes invariant against certain changes in the inputs. The specification of a target distribution for the work results now means that the standardized work results still belong to this target distribution, at least to a limited extent, even if the inputs fed to the neural network no longer belong to the domain and/or distribution of the training data used for training. Such a domain shift of the inputs with respect to the training data would normally cause the distribution of the obtained work results to also shift. By counteracting this, the normalization ensures that the further processing of the domain-shifted measurement data proceeds in the same way as the further processing of measurement data from the domain of the training data. After normalization, the neural network no longer notices that it has received domain-shifted measurement data.

The mapping to unit values mainly has the function of bringing the work results, whose numerical values can extend over many orders of magnitude, into the definition range of the cumulative density function in the interval [0,1]. It is inevitable here that some of the original information contained in the work results will be sacrificed. However, it was recognized that the most important information in the work results is the ranking of the work results among each other and that in comparison to this it is unimportant which absolute numerical values of the work results are used to express this ranking. Therefore, when mapping to the interval [0,1], exactly this ranking is preserved.

Invariance to domain shifts can bring significant savings in terms of training the neural network 1. For example, in the area of at least partially automated driving, training examples such as images or video sequences recorded during test drives are used. For supervised training of the neural network, these training examples must be labeled with target outputs that the neural network should output overall. This labeling is a manual, and therefore expensive, process. The training is then linked to the domain of those measurement data that the measurement setup used to capture the training examples, such as an arrangement of cameras and/or other sensors, is able to provide. If something is subsequently changed in this measurement setup, for example because a camera on the vehicle is moved to a different position and thus the perspective it observes changes, the measurement data recorded from then on belong to a domain that has been shifted to the domain of the original training examples. The method proposed here contributes to the fact that the domain shift is largely leveled out, and avoids the need for retraining or further training with the changed measurement setup, which requires bringing in and labeling many new training examples.

In a particularly advantageous embodiment of the present invention, the work results are mapped to quantiles as unit values. These quantiles indicate which numerical proportion of the other work results is less than the work result currently being considered. These unit values are therefore very well suited as arguments for the inverse cumulative density function, which is expressed in quantiles.

Calculating quantiles can, for example, include ascertaining a score for each of all the other work results that indicates the extent to which this work result is greater than or less than the work result currently being considered. These scores can then be averaged over these other work results. In this case, a score of 1 can be assigned to another work result that is greater than the work result currently being considered. However, another work result that is less than the work result currently being considered can be assigned a score of 0. This assignment, which corresponds to the Heaviside step function applied to pairwise differences between work results, can optionally be softened to make the calculation of the quantiles differentiable, for example.

In the above example of work results with numerical values 10000, 1000, 5, 3, and 2, work result 5, for example, is the work result currently being considered. The other work results 10000, 1000, 3, and 2 are included in the calculation of the quantile that represents this work result 5. The work results 10000 and 1000 each receive a score of 1 because they are greater than 5. Work results 3 and 2, on the other hand, each receive a score of 0 because they are less than 5. This results in a total of two score points, which are to be averaged over four work results. The quantile of the work result 5 is therefore 0.5.

According to an example embodiment of the present invention, particularly advantageously, a difference between another work result and the work result currently being considered can be processed by applying a sigmoid function to a score of this other work result. This function is 1 for positive arguments with a large magnitude and 0 for negative arguments with a large magnitude. In the transition region, the function increases continuously from 0 to 1. The application of a sigmoid function to the difference between the other work result and the work result currently being considered is therefore a differentiable approximation that simulates the application of the Heaviside step function to the work results.

In general, it is advantageous to choose a unit function that is a differentiable approximation of a discontinuous function. In particular, when back-propagating the feedback of a cost function to gradients of the parameters of neurons, a differentiable unit function is required. Otherwise, the gradients could not be propagated beyond the normalization. This is roughly comparable to the idea that dams in rivers are an insurmountable barrier for fish migrating upstream. To alleviate this problem, fish ladders are built at dams.

Both types of unit functions can also be combined. For example, the discontinuous but exact unit function can be used in the forward direction and the differentiable approximation can be used in the backward direction.

In another particularly advantageous embodiment of the present invention, the differentiable approximation is parameterized with a temperature parameter. Via this temperature parameter, a compromise between
the accuracy of the approximation on the one hand and
the speed at which this approximation saturates on the other hand
   can be set. In addition to the speed at which the approximation saturates, the number of derivatives of the approximation can also change. This number of derivatives is also called the “differentiability class” or the “smoothness” of a function. The temperature parameter can then, for example, be trained as a hyperparameter when training the neural network.

The temperature parameter can in particular be varied, for example, during training of the neural network according to a predetermined annealing plan. In this way, for example, convergence can be facilitated at the beginning of the training by using a softer, less accurate, but more differentiable approximation.

In a further particularly advantageous embodiment of the present invention, the work results comprise activations obtained by summing the inputs of the neuron in a weighted manner based on the parameters. Further processing of the normalized work results then comprises applying a specified nonlinear activation function to the normalized activations.

Depending on the number of inputs a neuron receives, the activations can develop a rapid dynamic behavior, and their numerical values can extend over many orders of magnitude within one and the same layer. Normalization ensures that all neurons of the layer can contribute to the output of this layer and that, for example, a few neurons do not monopolize the discussion about this output.

In a further advantageous embodiment of the present invention, the unit values are limited to a predetermined interval before being fed to the inverse cumulative density function. For example, it can be specified that the unit values must maintain at least a certain distance (for example 10⁻³) from the boundaries of the interval [0,1]. In this way, the standardized work results can be prevented from assuming non-finite values.

The target distribution can, for example, be in particular a normal distribution. Then most of the normalized activations are concentrated around a mean value, although outliers above and below can certainly occur. Alternatively, the target distribution can be, for example, another member of the exponential family or the Student's t-distribution.

As explained above, the ultimate goal of the normalization is to make the evaluation of measurement data more robust and more reliable with regard to the specific application at hand. Therefore, in another particularly advantageous embodiment, a control signal is determined from the outputs of the neural network. A vehicle, a driver assistance system, a robot, a quality control system, a system for monitoring areas, and/or a medical imaging system is controlled with the control signal. In this way, the probability is increased that the response to the control signal carried out by the correspondingly controlled technical system is appropriate in the situation embodied by the measurement data. This is especially true in cases in which the inputs to the neural network come from a domain that is shifted relative to the domain of the training data.

The method can in particular be wholly or partially computer-implemented. The present invention therefore also relates to a computer program comprising machine-readable instructions that, when executed on one or more computers and/or compute instances, cause the computer(s) and/or compute instances to execute the described method of the present invention. In this sense, control devices for vehicles and embedded systems for technical devices, which are also capable of executing machine-readable instructions, are also to be regarded as computers. Compute instances can be virtual machines, containers or serverless execution environments, for example, which can be provided in a cloud in particular.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for processing measurement data 9 in a neural network 1, according to the present invention.

FIG. 2 shows an illustration of the robustness against domain shift of the inputs 1a with respect to the training examples 1a*, which is effected by the method 100.

FIG. 3 shows a comparison of the effect of the method 100 to the effect of a conventional normalization method on inputs 1a that belong to different distributions.

### DETAILED DESCRIPTION OF EXAMPLE EMBODIMENTS

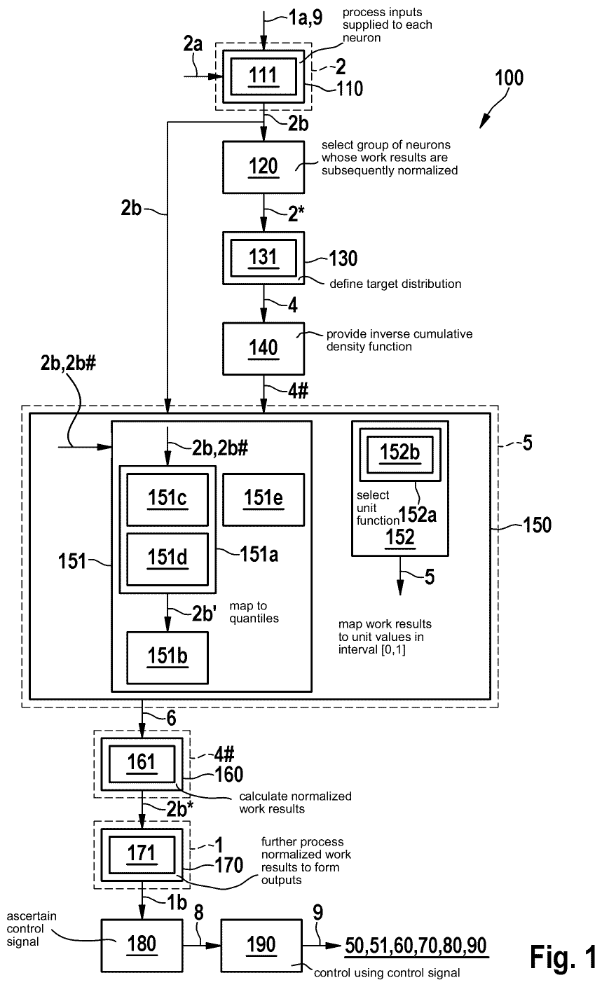

FIG. 1 shows a schematic flowchart of an exemplary embodiment of the method 100 for processing measurement data 9 in a neural network 1. This neural network 1 has a plurality of layers 3 of neurons 2. Here the outputs of neurons 2 of at least one layer 3 are each fed as inputs to neurons 2 of at least one subsequent layer 3.

In step 110, inputs supplied to each neuron 2 are processed according to parameters 2a associated with the neuron 2 to produce a work result 2b of that neuron 2.

According to block 111, the work results 2b can in particular comprise, for example, activations obtained by summing the inputs of the neuron 2 in a weighted manner based on the parameters 2a.

In step 120, a group 2* of neurons 2 whose work results 2b are to be subsequently normalized is selected.

In step 130, a target distribution 4 is defined for the work results 2b of the neurons 2 of this group 2*. The target distribution 4 is the distribution to which the standardized work results 2b* should belong.

According to block 131, for example, in particular a normal distribution or another member of the exponential family, or also the Student's t-distribution, can be selected as the target distribution 4.

In step 140, an inverse cumulative density function 4# of the target distribution 4 is provided.

In step 150, the work results 2b are mapped to unit values 6 in the interval [0,1] with a predetermined unit function 5. Then the unit value 6 corresponding to each work result 2b assumes the same rank in the list of all unit values 6 as the corresponding work result 2b in the list of all work results 2b.

According to block 151, the work results 2b can be mapped to quantiles as unit values 6, for example. These quantiles indicate which numerical proportion of the other work results 2b is less than the work result 2b# currently being considered.

According to block 151a, for all other work results 2b a score 2b′ can be ascertained in each case. This score 2b′ indicates to what extent the corresponding work result 2b is greater than or less than the work result 2b# currently being considered. The scores 2b′ can then be averaged over the other work results 2b according to block 151b.

In particular, for example, according to block 151c, a score of 1 can be assigned to another work result 2b that is less than the work result 2b# currently being considered. According to block 151d, on the other hand, a score of 0 can be assigned to another work result 2b that is less than the work result 2b# currently being considered.

According to block 151e, a difference of another work result 2b from the work result 2b# currently being considered can be processed by applying a sigmoid function to a score 2b′ of this other work result 2b. This softens, in a differentiable way, the discontinuous step function, which only distinguishes between the cases of whether the other work result 2b is greater than or less than the work result 2b# currently being considered.

According to block 152, a unit function 5 can thus generally be selected, which is a differentiable approximation of a discontinuous function.

This differentiable approximation can be parameterized, for example according to block 152a, with a temperature parameter via which a compromise between
the accuracy of the approximation on the one hand and
the speed at which this approximation saturates, on the other hand
   can be set.

This temperature parameter can be varied in particular, for example according to block 152b, during the training of the neural network 1 according to a predetermined annealing plan. As explained above, this can for example facilitate the convergence of training, especially at the beginning of training.

In step 160, normalized work results 2b* are calculated from the unit values 6 using the inverse cumulative density function 4#.

According to block 161, the unit values 6 can be restricted to a predetermined interval before being supplied to the inverse cumulative density function 4# (referred to as clamping). In particular, this can be used to prevent, for example, the inverse cumulative density function 4# from outputting a non-finite value exactly at the boundary of its definition range when an argument of 0 or 1 is entered.

In step 170, the normalized work results 2b* are further processed to form outputs 1b of the neural network 1 instead of the original work results 2b in the neural network 1. As explained above, this means that if a plurality of inputs 1a of the neural network are normalized to equal normalized work results 2b*, these inputs 1a can also ultimately be processed to form equal outputs 1b of the neural network 1. By normalizing the work results, the neural network 1 can thus, for example, learn invariance against a shift of the domain of the inputs 1a with respect to the domain from which the training examples 1a* used for training originate.

In the example shown in FIG. 1, in step 180 a control signal 8 is ascertained from the inputs 1b of the neural network 1. In step 190, a vehicle 50, a driver assistance system 51, a robot 60, a system 70 for quality control, a system 80 for monitoring areas, and/or a system 90 for medical imaging is controlled with the control signal 8.

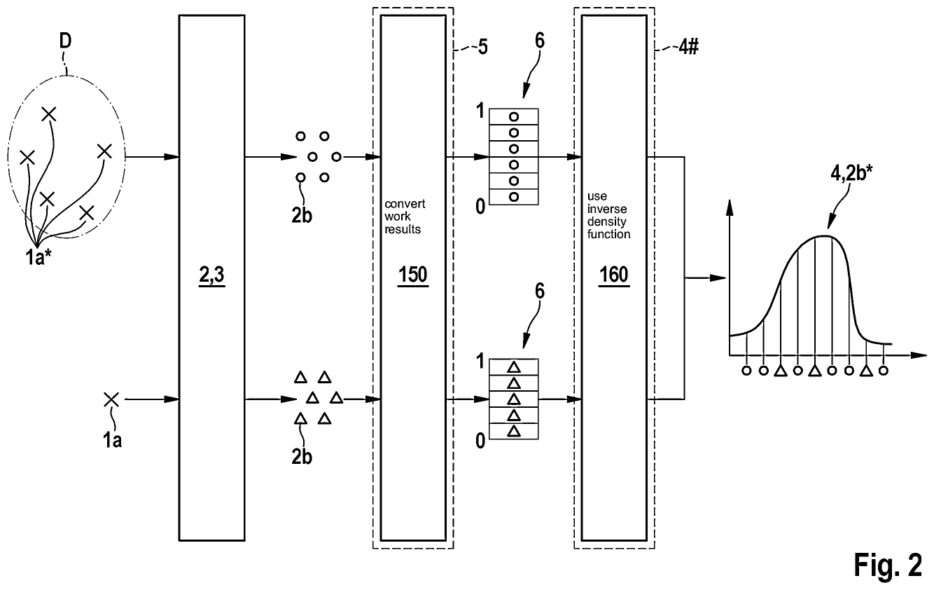

FIG. 2 illustrates how normalizing the work results 2b to form normalized work results 2b* can make the processing in the neural network 1 more robust against inputs 1a of the neural network 1 lying outside the domain and/or distribution D of the training examples 1a*.

The processing of the inputs 1a that lie outside the domain D initially leads to work results 2b that differ from the work results 2b obtained for the training examples 1a*. By converting the work results 2b in step 150 of the method 100 into unit values 6 using the unit function 5, the differences are at least leveled out to the extent that the unit values 6 are each in the same interval [0,1]. If these unit values 6 are now converted into standardized work results 2b* in step 160 using the inverse cumulative density function 4#, these standardized work results 2b* all belong to the predefined target distribution 4, here a normal distribution. This means that the standardized work results 2b* that resulted from the training examples 1a* and the standardized work results 2b* that resulted from new inputs 1a are all sorted according to the ranking of the corresponding unit values 6 on the abscissa axis under the target distribution function 4. All these standardized work results 2b* are now plausible samples that can be drawn from the target distribution 4. For further processing in the neural network 1, it therefore no longer makes a noticeable difference whether the normalized work results 2b* originally originate from a training example 1a* from the domain D or from a new input 1a that is shifted relative to this domain D. The neural network 1 thus becomes invariant to this domain shift.

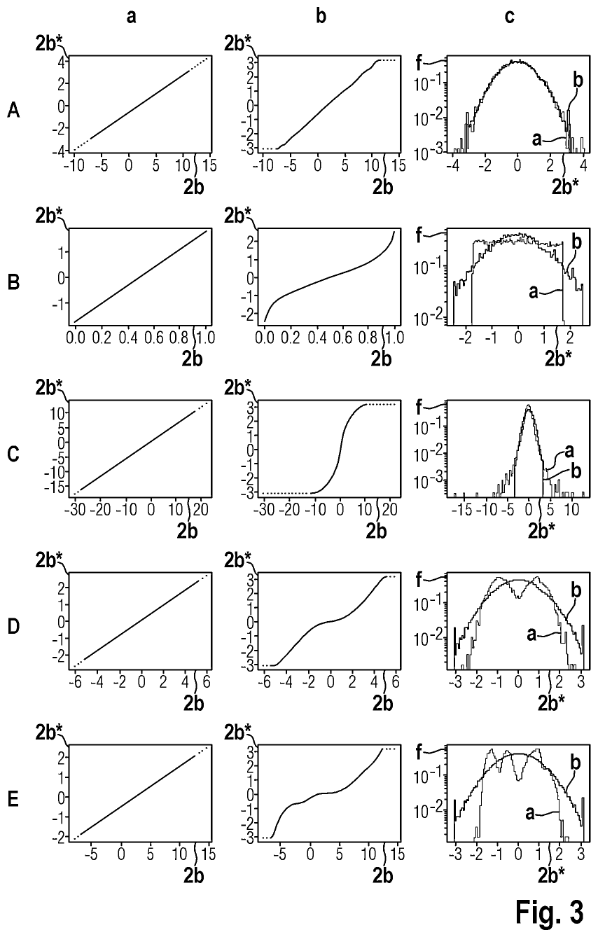

FIG. 3 illustrates the effect of the method 100 proposed here for normalizing work results 2b on the processing of inputs 1a belonging to different distributions:
In row A, the inputs 1a are normally distributed.
In row B, the inputs 1a are evenly distributed.
In row C, the inputs 1a are distributed according to the Student's t-distribution.
In row D, the inputs 1a are distributed bimodally.
In row E, the inputs 1a are distributed multimodally.

In each of the rows A to E, the following is plotted in each case:
in column a, the work results 2b*, normalized using a conventional normalization procedure, over the original work results 2b;
in column b, the work results 2b* normalized using the method 100 proposed herein, over the original work results 2b; and
in column c, frequency distributions of both the conventionally normalized work results 2b* (curve a) and the work results 2b* normalized using the method 100 proposed here, where probability densities f are plotted over the values of the work results 2b* in each case.

In the example shown in FIG. 3, the method 100 proposed here uses the normal distribution as a target distribution 4. The conventional normalization method is group normalization with a linear transformation.

Accordingly, for the conventional method, the relationship between the standardized work results 2b* and the original work results 2b is always linear. For the method 100 proposed here, this is only the case if the inputs 1a are normally distributed, which here corresponds to the target distribution 4. In all other cases the mapping is monolithic but not linear.

The frequency distributions of the work results 2b* normalized according to the procedure 100 proposed here are always substantially normally distributed, almost completely independently of the distribution of the inputs 1a. In contrast, the conventionally normalized work results 2b* are normally distributed only if the inputs 1a are also normally distributed. Otherwise it will not be possible, or only very incompletely, to suppress the occurrence of multiple modes or even very strong offshoots.

This makes it clear that the method 100 proposed here is particularly advantageous for the operation of smaller neural networks 1 with comparatively few features. In larger neural networks 1, the law of large numbers causes the distribution of work results 2a to automatically approach the normal distribution. In smaller neural networks 1, i.e. especially in neural networks 1 with fewer than approximately 100 neurons 2, it becomes significantly less probable that the working results 2a are already normally distributed.

1-15. (canceled)

16. A method for processing measurement data in a neural network, the neural network including a plurality of layers of neurons, wherein outputs of neurons of at least one layer are each fed as inputs into neurons of at least one subsequent layer, the method comprising the following steps:
processing inputs supplied to each neuron according to parameters associated with the neuron to produce a respective work result of the neuron;
selecting a group of neurons is selected;
defining a target distribution for the respective work results of the neurons of the group;
provide an inverse cumulative density function of the target distribution;
mapping the respective work results of the neurons of the group with a predetermined unit function onto unit values in an interval [0,1], so that the unit value associated with each respective work result occupies a same rank on a list of all unit values as the respective work result occupies on a list of all respective work results;
calculating normalized work results from the unit values using the inverse cumulative density function; and
further processing the normalized work results to produce outputs of the neural network instead of original work results in the neural network.

17. The method according to claim 16, wherein the respective work results are mapped as unit values to quantiles that indicate which numerical proportion of the other respective work results is less than the respective work result currently being considered.

18. The method according to claim 16, wherein:
for all other respective work results, a score is ascertained that indicates the extent to which the respective work result is greater than or less than the respective work result currently being considered, and
the scores are averaged over the other respective work results.

19. The method according to claim 18, wherein:
a score of 1 is assigned to another respective work result that is greater than the respective work result currently being considered, and
a score of 0 is assigned to another respective work result that is less than the respective work result currently being considered.

20. The method according to claim 18, wherein a difference of another respective work result from the respective work result currently being considered is processed by applying a sigmoid function to a score of the other respective work result.

21. The method according to claim 16, wherein the unit function is a differentiable approximation of a discontinuous function.

22. The method according to claim 21, wherein the differentiable approximation is parameterized with a temperature parameter via which a compromise between an accuracy of the differentiable approximation on the one hand and a speed at which the differentiable approximation saturates, on the other hand can be set.

23. The method according to claim 22, wherein the temperature parameter is varied during training of the neural network according to a predetermined annealing plan.

24. The method according to claim 16, wherein:
the respective work results include activations obtained by summing the inputs of the neuron in a weighted manner based on the parameters associated with the neuron, and
the further processing of the normalized work results includes applying a predetermined non-linear activation function to the normalized activations.

25. The method according to claim 16, wherein the unit values are limited to a predetermined interval before being supplied to the inverse cumulative density function.

26. The method according to claim 16, wherein the target distribution is: (i) a normal distribution, or (ii) a member of an exponential family, or (iii) a Student's t-distribution.

27. The method according to claim 16, wherein:
a control signal is ascertained from the outputs of the neural network, and
a vehicle, and/or a driving assistance system, and/or a robot, and/or a system for quality control, and/or a system for monitoring areas, and/or a system for medical imaging, is controlled with the control signal.

28. A non-transitory machine-readable data carrier on which is stored a computer program including machine-readable instructions for processing measurement data in a neural network, the neural network including a plurality of layers of neurons, wherein outputs of neurons of at least one layer are each fed as inputs into neurons of at least one subsequent layer, the instructions, when executed by one or more computers and/or compute instances, causing the one or more computers and/or compute instances to perform the following steps:
processing inputs supplied to each neuron according to parameters associated with the neuron to produce a respective work result of the neuron;
selecting a group of neurons is selected;
defining a target distribution for the respective work results of the neurons of the group;
provide an inverse cumulative density function of the target distribution;
mapping the respective work results of the neurons of the group with a predetermined unit function onto unit values in an interval [0,1], so that the unit value associated with each respective work result occupies a same rank on a list of all unit values as the respective work result occupies on a list of all respective work results;
calculating normalized work results from the unit values using the inverse cumulative density function; and
further processing the normalized work results to produce outputs of the neural network instead of original work results in the neural network.

29. One or more computers and/or compute instances equipped with a non-transitory machine-readable data carrier on which is stored a computer program including machine-readable instructions for processing measurement data in a neural network, the neural network including a plurality of layers of neurons, wherein outputs of neurons of at least one layer are each fed as inputs into neurons of at least one subsequent layer, the instructions, when executed by the one or more computers and/or compute instances, causing the one or more computers and/or compute instances to perform the following steps:
processing inputs supplied to each neuron according to parameters associated with the neuron to produce a respective work result of the neuron;
selecting a group of neurons is selected;
defining a target distribution for the respective work results of the neurons of the group;
provide an inverse cumulative density function of the target distribution;
mapping the respective work results of the neurons of the group with a predetermined unit function onto unit values in an interval [0,1], so that the unit value associated with each respective work result occupies a same rank on a list of all unit values as the respective work result occupies on a list of all respective work results;
calculating normalized work results from the unit values using the inverse cumulative density function; and
further processing the normalized work results to produce outputs of the neural network instead of original work results in the neural network.
